(19) United States
(12) Patent Application Publication
(10) Pub. No.: US 2013/0232374 A1
(43) Pub. Date: Sep. 5, 2013

(54) REMOTELY SERVICING AND DIAGNOSING ELECTRONIC DEVICES

(71) Applicants: Charles McCoy, Coronado, CA (US); Aran Sadja, San Diego, CA (US); Ling Jun Wong, Champaign, IL (US); True Xiong, San Diego, CA (US)

(72) Inventors: Charles McCoy, Coronado, CA (US); Aran Sadja, San Diego, CA (US); Ling Jun Wong, Champaign, IL (US); True Xiong, San Diego, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/411,289

(22) Filed: Mar. 2, 2012

(51) Int. Cl. G06F 11/30

(52) U.S. Cl. 714/4.1; 714/E11.179

(57) ABSTRACT

Remotely servicing and diagnosing a client device, including: establishing a persistent two-way connection between a server and the client device using a messaging and presence protocol; reading and analyzing statistics and settings of the client device when the persistent two-way connection has been established; detecting any problem with the client device from reading and analyzing statistics and setting of the client device; addressing and fixing the problem with the client device. Keywords include persistent connection, and remote servicing and diagnosing.

### BACKGROUND

1. Field of the Invention

The present invention relates to remote service and control, and more specifically, to remotely servicing and diagnosing electronic devices.

2. Background

A remote computer can be accessed and controlled using remote access services via a computer network. For example, a remote access server process executing on the remote computer may establish an operating system instance is having a desktop display and one or more executing applications. This operating system may then be instantiated locally by executing a remote access client to interface with the instance using a graphical user interface.

### SUMMARY

The present invention provides for remotely servicing and diagnosing a client device.

In one implementation, a method of remotely servicing and diagnosing a client device is disclosed. The method includes: establishing a persistent two-way connection between a server and the client device using a messaging and presence protocol; reading and analyzing statistics and settings of the client device when the persistent two-way connection has been established; detecting any problem with the client device from reading and analyzing statistics and setting of the client device; and addressing and fixing the problem with the client device.

In another implementation, a remote device servicing system is disclosed. The system includes: an interface unit configured to communicate with a client device to establish a persistent two-way connection using a messaging and presence protocol; and a service/diagnostics unit configured to query and control the client device through the persistent two-way connection, wherein the service/diagnostics unit streams markup language elements using the messaging and present protocol to exchange messages and presence information in near-real-time, wherein the service/diagnostics unit reads and analyzes statistics and settings of the client device, detects and fixes any problem with the client device.

In yet another implementation, a non-transitory storage medium storing a computer program to remotely service and diagnose a client device is disclosed. The computer program includes executable instructions that cause a computer to: establish a persistent two-way connection between a server and the client device using a messaging and presence protocol; read and analyze statistics and settings of the client device when the persistent two-way connection has been established; detect any problem with the client device from reading and analyzing statistics and setting of the client device; and address and fix the problem with the client device.

Other features and advantages of the present invention will become more readily apparent to those of ordinary is skill in the art after reviewing the following detailed description and accompanying drawings.

### BRIEF DESCRIPTION OF THE DRAWINGS

FIG. 1 is a functional block diagram of a remote device servicing system in accordance with one implementation of the present invention.

FIG. 2 is a flowchart illustrating a method of remotely servicing and diagnosing electronic devices in accordance with one implementation of the present invention.

FIG. 3A illustrates a representation of a computer system and an agent.

FIG. 3B is a functional block diagram illustrating the computer system hosting the remote device servicing manager.

### DETAILED DESCRIPTION

Certain implementations as disclosed herein provide for remotely servicing and diagnosing electronic devices by enabling a customer service to query and control the devices using a messaging and presence protocol. After reading this description it will become apparent how to implement the invention in various implementations and applications. Although various implementations of the present invention will be described herein, it is understood that these implementations are presented by way of example only, and not limitation. As such, this detailed description of various implementations should not be construed to limit the scope or breadth of the present invention.

In one implementation, remotely servicing and diagnosing electronic devices includes enabling a server to query and control a client's electronic device through a persistent two-way connection using a messaging and presence protocol. Once the connection is established, the server would then be able to read and analyze client device statistics and settings that were queried from the client device. The server could also use the connection to control and update the client device. Further, the server could use the connection to detect any problem with the client device, and determine whether the problem can be fixed through a configuration or setting change.

The advantages of the persistent connection using a messaging and presence protocol such as Extensible Messaging and Presence Protocol (XMPP) include automatic servicing and diagnosing of the client device. For example, directly accessing and diagnosing the client device substantially reduces the need for direct customer interface which removes difficulties in terms of a language barrier and/or technical knowledge. That is, having the persistent connection to the client device enables the customer service agent to work directly with the client device rather than interact with the user of the client device who would interact with the client device and describe the results to the agent. This would allow the customer service agent to diagnose and correct the problem in the client device in much less time.

In another implementation, remote servicing and diagnosing of electronic devices includes enabling the client device to select an item on a menu which would cause the client device to establish a connection with a customer service agent using a messaging and presence protocol. In one implementation, the customer service agent is co-located with the server. In another implementation, the customer service agent is remotely located from the server. The customer service agent would then respond with a session ID that would be displayed to the user of the client device. The agent uses that session ID to attach to the client device's session and detect and fix any problem with the client device. For example, a console of a customer service agent can query features and settings from the client device and display them on the console for the agent to read the features and settings, without having to ask the user to find and read settings from the client device. The console can even query and display information about the client device that is not accessible through the user interface of the client device, and would therefore not have previously been available by asking the user to interact with the client device and describe the state of the device. This information could describe the inner workings of the client device and provide information that would be very helpful to the customer service agent in determining the cause of the problem. The customer service agent can then control the device through the console and observe the behavior of the client device and how the settings change. The customer service agent can also directly change settings on the client device through the console. The console could also perform some automated diagnostics through the querying of the client device that is available to it. This would allow the console to suggest probable causes of the problem along with recommended solutions for that problem. The automated diagnostics service could even use the device control available through the XMPP session to perform automated tests to better narrow down the causes of the problem and fix it. The console can then repeat the steps that caused the problem and confirm that the problem no longer exists.

In yet another implementation, a system of servicing and diagnosing of client devices can be facilitated by configuring the system within the infrastructure of an existing private relationship such as a server-client relationship. Once the private relationship is established between the client device and the server, capabilities of the client device and preferences of the user of the client device can be ascertained. For example, preferences include heuristic behaviors such as viewing, selecting, searching, processing and recommending content category, title, types, and other related parameters by the user. Further, once the private relationship is established between the client device and the server, that relationship can be maintained and updated using the messaging and presence protocol of the persistent two-way connection. That is, the persistent connection between the client device and the server enables the server to read and analyze client device statistics and settings, control and update the client device, detect any problem with the client device, and determine whether the problem can be fixed through a configuration or setting change.

In some implementations, the client device includes a consumer electronic appliance such as an audio system, video player, or television. In other implementations, the client device includes an Internet-related device such as a modem, router, or gateway.

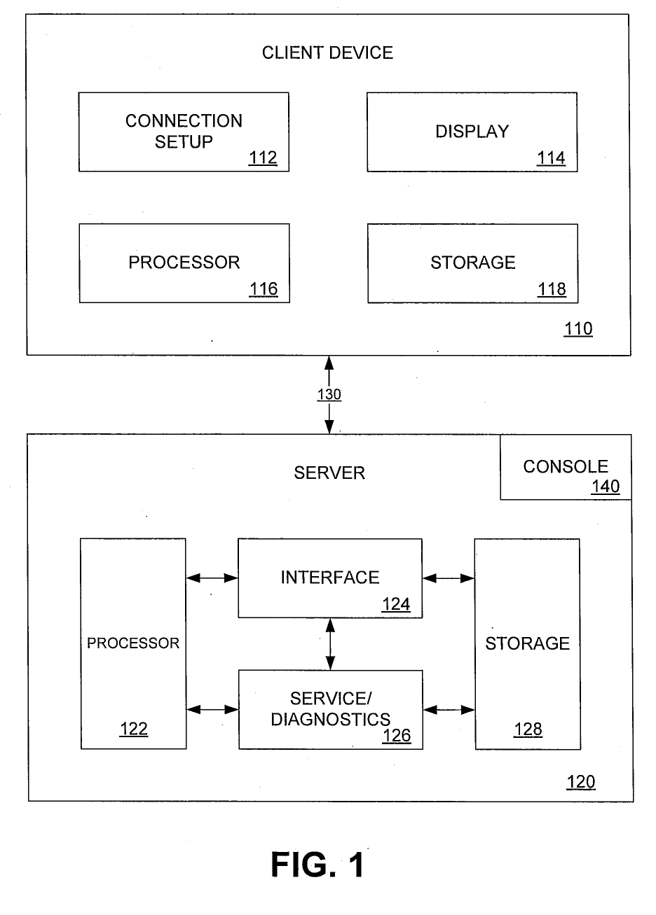

FIG. 1 is a functional block diagram of a remote device servicing system 100 in accordance with one implementation of the present invention. In the illustrated implementation of FIG. 1, the server 120, which is in communication with a client device 110, also includes a processor 122, an interface 124, a service/diagnostics unit 126, and storage 128. The client device 110 includes a connection setup unit 112, a display 114, a processor 116, and storage 118. In one example, the server 110 can be configured as a Bravia Internet Video Link (BIVL) system which provides video streaming and on-demand services accessible through a client device (e.g., home appliances such as a television). Further, the client device 110 can be configured as an Internet Protocol Television (IPTV) unit.

In one implementation, the service/diagnostics unit 126 queries and controls the client's electronic device through a persistent two-way connection using a messaging and presence protocol. The interface unit 124 communicates with the connection setup unit 112 to establish the persistent two-way connection using the messaging and presence protocol such as XMPP. In one implementation, the service/diagnostics unit 126 can stream markup language elements using the XMPP to exchange messages and presence information in near-real-time. Since the architecture of a network built using the XMPP is similar to an email system, configuration and maintenance of the server 120 can be quite easy.

Once the connection is established, the processor 122 of the server 120 would then be able to read and analyze statistics and settings of the client device 110, store them in storage 118, and transfer them to storage 128. The processor 122 could also use the connection established by the interface unit 124 and the connection setup unit 112 to control and update the client device 110. Further, the processor 122 could use the connection to detect any problem with the client device 110, and determine whether is the problem can be fixed through a configuration or setting change. If the problem can be fixed, then the configuration or setting of the client device is updated.

The persistent connection 130 between the server 120 and the client device 110 enables the customer service agent to work directly with the client device 110 rather than interact with the user of the client device who would interact with the client device and describe the results to the agent. This would allow the customer service agent to diagnose and correct the problem in the client device 110 in much less time.

In another implementation, the connection setup unit 112 selects an item on a menu which would establish a connection with a customer service agent (not shown) using a messaging and presence protocol. In one implementation, the customer service agent is co-located with the server 120. In another implementation, the customer service agent is remotely located from the server 120. The customer service'agent would then respond with a session ID that would be displayed to the user on the display 114. The agent uses that session ID relayed to the agent by the user to attach to the client device's session and detect and fix any problem with the client device 110. For example, a console 140 of the customer service agent can query features and settings from the client device 110 and display them on the console 140 for the agent to read the features and settings, without having to ask the user to find and read settings from the client device 110. The console 140 can even query and display information about the client device 110 that is not accessible through the user interface of the client device 110, and would therefore not have previously been available by asking the user to interact with the client device and describe the state of the device. This information could describe the inner workings of the client device 110 and provide information that would be very helpful to the customer service agent in determining the cause of the problem. The customer service agent can then control the device 110 through the console 140 and observe the behavior of the client device 110 and how the settings change. The customer service agent can also directly change settings on the client device 110 through the console 140. The console 140 could also perform some automated diagnostics through the querying of the client device 110 that is available to it. This would allow the console 140 to suggest probable causes of the problem along with recommended solutions for that problem. The console 140 can then repeat the steps that caused the problem and confirm that the problem no longer exists.

In a further implementation, the remote device servicing system 100 can be facilitated by configuring the system within the infrastructure of an existing private relationship such as a server-client relationship. Once the private relationship is established between the client device 110 and the server 120, capabilities of the client device 110 and preferences of the user of the client device can be ascertained. For example, preferences include heuristic behaviors such as viewing, selecting, searching, processing and recommending content category, title, types, and other related parameters by the user. Further, once the private relationship is established between the client device 110 and the server 120, that relationship can be maintained and updated by the processor 122 using the messaging and presence protocol of the persistent two-way connection. That is, the persistent connection between the client device 110 and the server 120 enables the server to read and analyze statistics and settings of the client device 110, control and update the client device 110, detect any problem with the client device 110, and is determine whether the problem can be fixed through a configuration or setting change.

In some implementations, the client device 110 includes a consumer electronic appliance such as an audio system, video player, or television. In other implementations, the client device 110 includes an Internet-related device such as a modem, router, or gateway.

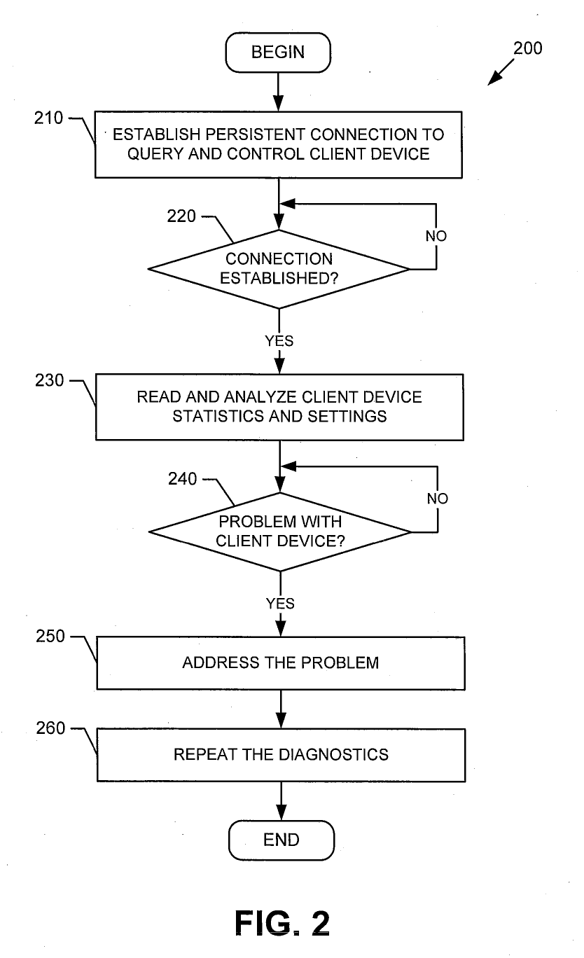

FIG. 2 is a flowchart 200 illustrating a method of remotely servicing and diagnosing electronic devices in accordance with one implementation of the present invention. In the illustrated implementation of FIG. 2, a persistent two-way connection using a messaging and presence protocol between the server and the client device is established, at box 210, to query and control the client device. A query is made, at box 220, to determine whether the connection has been established. Once the connection is established, at box 220, client device statistics and settings are read and analyzed, at box 230. The connection can also be used to control and update the client device. At box 240, a query is then made to determine whether any problem has been detected with the client device, and whether the problem can be fixed through a configuration or setting change. The problem with the client device is address, at box 250, to solve the problem. For example, depending on the problem, the settings on the client device are directly changed, or some automated diagnostics are performed to further isolate the problem. In another example, software residing within the client device can be replaced or updated. At box 260, diagnostics (e.g., boxes 230 to 250) are repeated to verify that the problem has been solved.

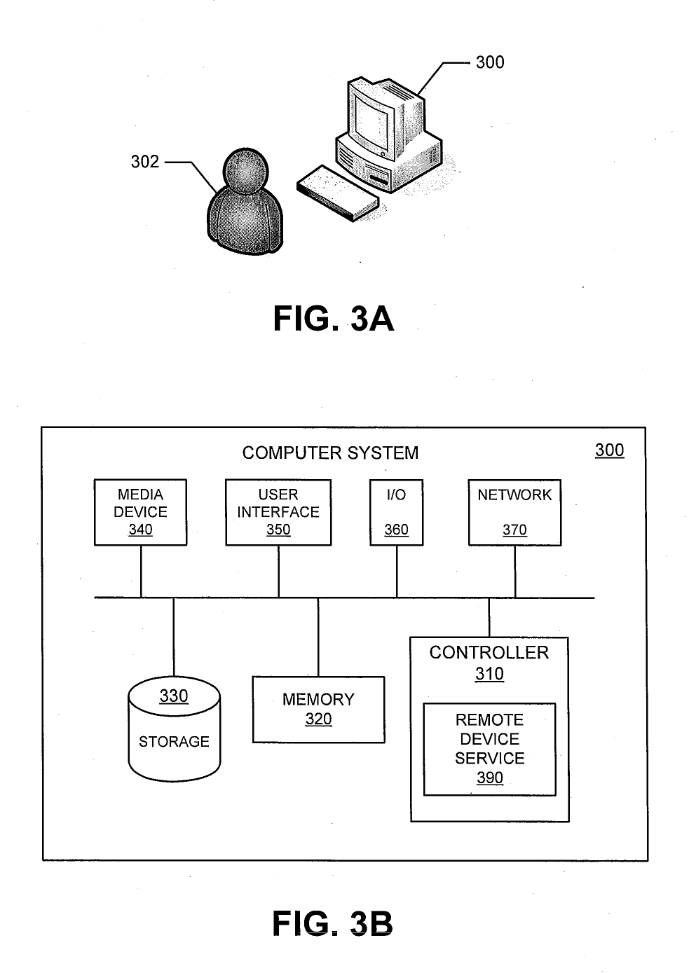

FIG. 3A illustrates a representation of a computer system 300 and an agent 302. The agent 302 uses the computer system 300 to provide remote device servicing. The computer system 300 stores and executes a remote device servicing manager 390.

FIG. 3B is a functional block diagram illustrating the computer system 300 hosting the remote device servicing manager 390. The controller 310 is a programmable processor and controls the operation of the computer system 300 and its components. The controller 310 loads instructions (e.g., in the form of a computer program) from the memory 320 or an embedded controller memory (not shown) and executes these instructions to control the system. In its execution, the controller 310 provides the remote device servicing manager 390 as a software system. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Non-transitory storage 330 stores data for use by other components of the computer system 300, such as for storing data used by the remote device servicing manager 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the agent 302 and presenting information to the agent 302. In one implementation, the user interface 350 includes a keyboard, a mouse, audio speakers, and a display. The controller 310 uses input from the agent 302 to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 302.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

The above description of the disclosed implementations is provided to enable any person skilled in the art to make or use the invention. Various modifications to these implementations will be readily apparent to those skilled in the art, and the generic principles described herein can be applied to other implementations without departing from the spirit or scope of the invention. Accordingly, additional implementations and variations are also within the scope of the invention. For example, although the specification focuses on a persistent connection using the messaging and presence protocol, any protocol that involves markup language elements can be used. Thus, the system can piggyback on other applications such as an email or chat application. Further, it is to be understood that the description and drawings presented herein are representative of the subject matter which is broadly contemplated by the present invention. It is further understood that the scope of the present invention fully encompasses other implementations that may become obvious to those skilled in the art and that the scope of the present invention is accordingly limited by nothing other than the appended claims.

1. A method of remotely servicing and diagnosing a client device, the method comprising:
establishing a persistent two-way connection between a server and the client device using a messaging and presence protocol;
reading and analyzing statistics and settings of the client device when the persistent two-way connection has been established;
detecting any problem with the client device from reading and analyzing statistics and setting of the client device; and
addressing and fixing the problem with the client device.

2. The method of claim 1, further comprising
performing reading and analyzing statistics and settings of the client device again to verify that the problem with the client device has been fixed.

3. The method of claim 1, wherein addressing and fixing the problem comprises
controlling and updating the client device.

4. The method of claim 1, wherein addressing and fixing the problem comprises:
determining whether the problem can be fixed through a configuration or setting change; and
updating the configuration or setting of the client device.

5. The method of claim 1, wherein the messaging and to presence protocol is Extensible Messaging and Presence Protocol (XMPP).

6. The method of claim 1, wherein establishing a persistent two-way connection comprises
is enabling the client device to select an item on a menu.

7. The method of claim 1, wherein establishing a persistent two-way connection comprises
establishing the persistent two-way connection within an infrastructure of an existing private server-client relationship.

8. A remote device servicing system, comprising:
an interface unit configured to communicate with a client device to establish a persistent two-way connection using a messaging and presence protocol; and
a service/diagnostics unit configured to query and control the client device through the persistent two-way connection,
wherein the service/diagnostics unit streams markup language elements using the messaging and present protocol to exchange messages and presence information in near-real-time,
wherein the service/diagnostics unit reads and analyzes statistics and settings of the client device, detects and fixes any problem with the client device.

9. The system of claim 8, wherein the client device is one of an audio system, video player, and television.

10. The system of claim 8, wherein the client device is one of a modem, router, or gateway.

11. The system of claim 8, wherein the client device is an Internet Protocol Television (IPTV) unit.

12. A non-transitory storage medium storing a computer program to remotely service and diagnose a client device, the computer program comprising executable instructions that cause a computer to:
establish a persistent two-way connection between a server and the client device using a messaging and presence protocol;
read and analyze statistics and settings of the client device when the persistent two-way connection has been established;
detect any problem with the client device from reading and analyzing statistics and setting of the client device; and
address and fix the problem with the client device.

13. The non-transitory storage medium of claim 12, further comprising executable instructions that cause a computer to
read and analyze statistics and settings of the client device again to verify that the problem with the client device has been fixed.

14. The non-transitory storage medium of claim 12, wherein executable instructions that cause a computer to address and fix the problem comprise executable instructions that cause a computer to
control and update the client device.

15. The non-transitory storage medium of claim 12, wherein executable instructions that cause a computer to address and fix the problem comprise executable instructions that cause a computer to:
determine whether the problem can be fixed through a configuration or setting change; and
update the configuration or setting of the client device.

16. The non-transitory storage medium of claim 12, wherein the messaging and presence protocol is Extensible Messaging and Presence Protocol (XMPP).

17. The non-transitory storage medium of claim 12, wherein executable instructions that cause a computer to establish a persistent two-way connection comprise executable instructions that cause a computer to
enable the client device to select an item on a menu.

18. The non-transitory storage medium of claim 12, wherein executable instructions that cause a computer to establish a persistent two-way connection comprise executable instructions that cause a computer to
establish the persistent two-way connection within an infrastructure of an existing private server-client relationship.
